(19) United States
(12) Patent Application Publication
(10) Pub. No.: US 2015/0377154 A1
(43) Pub. Date: Dec. 31, 2015

(54) TEMPORARY RENTAL OF ENGINE RECALIBRATION

(71) Applicant: International Engine Intellectual Property Company, LLC, Lisle, IL (US)

(72) Inventors: Lee Tran, Carol Stream, IL (US); Askin Minaz, Aurora, IL (US); Ravi Rayala, Aurora, IL (US); Suttisak Pardungkiattisak, Carol Stream, IL (US)

(21) Appl. No.: 14/708,911

(22) Filed: May 11, 2015

Related U.S. Application Data
(60) Provisional application No. 62/018,812, filed on Jun. 30, 2014.

(51) Int. Cl. F02D 29/02

(52) U.S. Cl. CPC F02D 29/02

(57) ABSTRACT

Increased rated output power of a motor vehicle's engine can be temporarily rented by the user of the vehicle from the engine manufacturer.

### TECHNICAL FIELD

The disclosed subject matter relates to commercial motor vehicles which are propelled by internal combustion engines.

### BACKGROUND

Commercial motor vehicles are commonly classified according to gross vehicle weight (GVW) and grouped as light-, medium-, and heavy-duty vehicles. For example, a Class 8 truck is a heavy-duty vehicle. Within a given class, different vehicles may have different engines which differ in various ways such as by manufacturer, size, and rated output power.

A user of a commercial vehicle typically purchases a vehicle whose engine has sufficient rated output power for the vehicle's intended vocation. Because the price of an engine is a major factor in the price of a commercial vehicle, a commercial user is unlikely to purchase a vehicle with an engine which has higher rated power than is typically needed for the intended vocation.

### SUMMARY

A user of a commercial vehicle may on occasion experience situations where that vehicle's rated power is insufficient to satisfy a particular need. For example, when a vehicle which typically operates within a geographical area whose roads lack steep grades has a business opportunity that requires travel in a different geographical region which has steep grades, the user may be unable to take advantage of that opportunity out of concern that it will be underpowered for such grades. A business opportunity may be lost in the same way when the vehicle needs to carry a heavier than usual load which is still within the GVW rating of the body and chassis vehicle.

The present disclosure relates to a method which can enable a commercial vehicle user to take advantage of such opportunities which otherwise might be lost because of insufficient engine power.

The method provides a convenient way for endowing the engine of a user's commercial vehicle with increased rated output power when greater power is needed for short-term use. In this way, the user need not purchase a vehicle having a more expensive engine whose rated output power would seldom be used, and instead can have an engine's rated output power temporarily increased by the engine manufacturer.

The temporary increase in rated output power is purchased by the user from the engine manufacturer. In other words the increase is rented is rented for a limited duration of allowed use.

Rated output power is increased by the engine manufacturer wirelessly transmitting recalibration data to a wireless receiver in the commercial vehicle for enabling its engine to be recalibrated to increased rated output power. The received recalibration data is installed in a control system of the engine and when the engine operates, becomes operational to the exclusion of original calibration data which may have been either removed from the control system or merely deactivated.

The price which the engine manufacturer charges the user may be set in various ways, such as by measuring time of operation of the engine when using the recalibration data and basing the price on that length of time.

Upon expiration of the limited duration of allowed use, the original calibration data, if previously removed, is restored by wirelessly transmitting original calibration data to the wireless receiver for enabling the engine to be returned to original calibration by causing the original calibration data to be installed in the control system and to become operational when the engine is re-started. If the original calibration data has only been deactivated, it is simply reactivated.

The ability to rent increased power on a short-term basis can be a marketing feature for commercial vehicle manufacturers, potentially leading to increased market share. Using wireless (i.e. over-the-air) technology avoids a trip to a service facility and enables engine power to be quickly and efficiently increased.

One general aspect of the disclosed subject matter relates to a method for enabling and causing an internal combustion engine of a motor vehicle to be recalibrated, for a limited duration of use, from a first calibration which sets a first value of a performance parameter for the engine, to a second calibration which sets a second value of the performance parameter different from the first value.

The method comprises a manufacturer of the engine specifying conditions which a user of a motor vehicle having an internal combustion engine manufactured by the manufacturer must accept as a prerequisite to fulfillment of a request by the user for recalibration of the engine, the conditions including a limited duration for which use of the second calibration is allowed.

The user requests, from a source having the manufacturer's authority to enable and cause the engine be recalibrated pursuant to the conditions, that the engine be recalibrated.

Upon being informed of the user's acceptance of the conditions, the source initiates actions of wirelessly transmitting data for the second calibration to a wireless receiver in the motor vehicle, causing the data for the second calibration to be installed in a control system of the engine and to become available for use by the control system at a beginning of the limited duration of use, and to become unavailable for use by the control system at an end of the limited duration of use.

Another general aspect of the disclosed subject matter relates to a system for enabling an internal combustion engine of a motor vehicle to be recalibrated, for a limited duration of use, from a first calibration which sets a first value of a performance parameter for the engine, to a second calibration which sets a second value of the performance parameter different from the first value.

The system comprises: a data processor which operates under authority of a manufacturer of internal combustion engines and comprises a data base which includes: 1) data about various internal combustion engines manufactured by the manufacturer and used in various motor vehicles, the data base including data for recalibrating an engine in a selected vehicle from a first calibration which currently sets a first value of a performance parameter for the engine, to a second calibration which sets a second value of the performance parameter different from the first value, and 2) data which defines specific conditions which a user of a particular motor vehicle having an internal combustion engine manufactured by the manufacturer must accept as a prerequisite to the data processing system's fulfillment of a request by the user to recalibrate the engine of the particular motor vehicle, the conditions including a limited duration for which use of the second calibration is allowed.

The user can access the data processor via a user interface via which the user inputs certain information about the user's motor vehicle and engine for processing in accordance with an algorithm which discloses suitability of the engine for recalibration and which specifies conditions which the user must accept as a prerequisite to fulfillment of a request by the user for recalibration of the engine, and via which the user communicates to the data processor the user's acceptance of the conditions to cause the data processor to initiate recalibration of the engine of the particular motor vehicle.

The foregoing summary is accompanied by further detail of the disclosure presented in the Detailed Description below with reference to the following drawings which are part of the disclosure.

### BRIEF DESCRIPTION OF THE DRAWINGS

FIG. 1 is general schematic diagram of interactions between a commercial vehicle user and an engine manufacturer which occur in when a temporary increase in engine output power is rented from the engine manufacturer.

FIG. 2 is a graph plot containing original and temporary power and torque plots for an engine.

FIG. 3 is a sequence of general steps in the disclosed method.

FIG. 4 is a diagram of an algorithm for performing the method.

### DETAILED DESCRIPTION

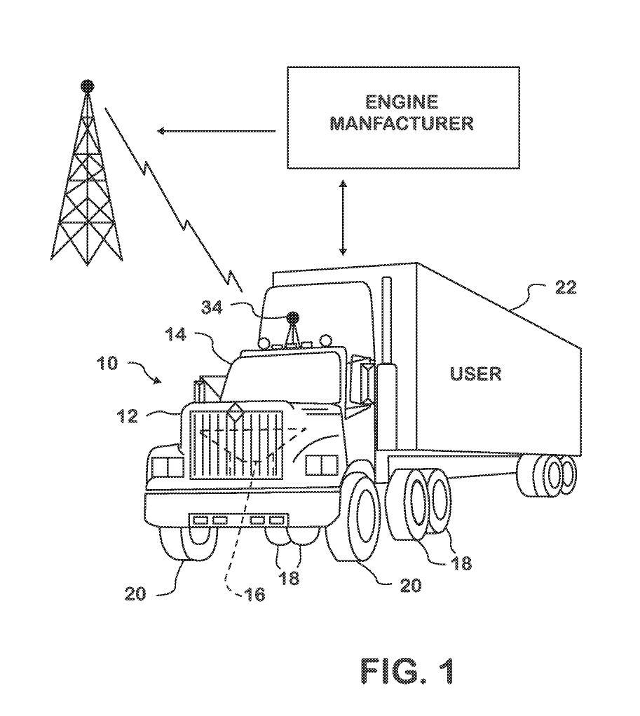

FIG. 1 shows an example of a commercial truck 10 belonging to a user which, for example, may be a trucking company, a business, or an individual. Under a hood 12 in front of a cab body 14 is an internal combustion engine 16 which is part of a powertrain which propels truck 10 via rear drive wheels 18. Truck 10 is steered via front steered wheels 20. Truck 10 is a highway tractor which has the capability of pulling a trailer 22.

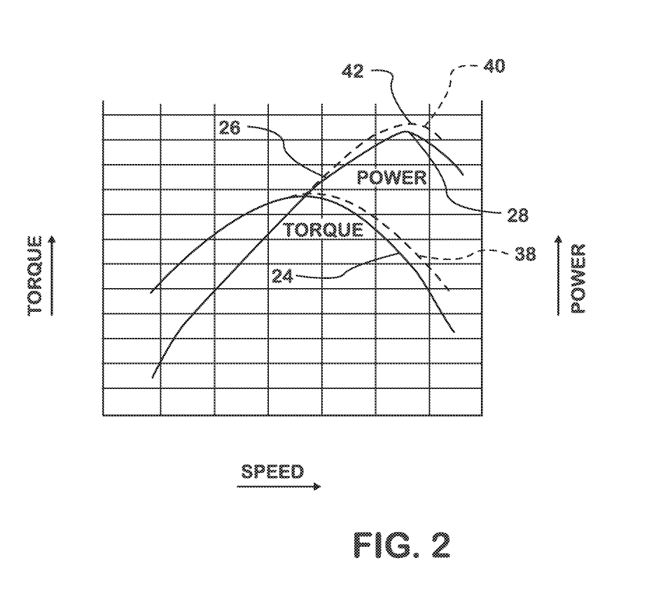

Engine 16 has a certain rated output power which is explained with reference to a non-dimensional graphic portrayal in FIG. 2. A trace 24 shows a relationship of engine output torque to engine speed, and a trace 26 shows a relationship of engine output power to engine speed. Power trace 26 has a maximum at the point marked 28, and that point is one way to quantize the rated output power of engine 16.

Engine 16 is sold by its manufacturer with a control system which is calibrated to set the rated output power of the engine. The control system includes an electronic processor, sometimes called an ECU standing for “electronic control unit”, which contains calibration data that establishes the rated output power of the engine. The calibration data calibrates various engine sub-systems such as fueling, exhaust gas recirculation (EGR), turbocharger, etc. Engine operation is controlled by control algorithms in the ECU processing various data including sub-system calibration data. The control algorithms and calibration data may be proprietary to the engine manufacturer and hence protected in the processor against unauthorized access by other than the engine manufacturer and its authorized agents. In that way, theft of proprietary data and tampering with the control system which could void an engine warranty are discouraged.

Good engine design practice provides some design margin of safety in engine components which would allow an engine to be modified to have rated output power which is somewhat greater than its original rated output power. With that recognition, a temporary, non-excessive but nonetheless significant increase in an engine's rated output power, as determined at the discretion of the engine manufacturer, becomes possible.

The disclosed method provides the user of truck 10 an opportunity to obtain such an increase via communication with an engine manufacturer as suggested in FIG. 1. The engine manufacturer may publish informational detail about the temporary rental of increased rated output power of its engines, such as price and duration for which increased rated output power can be used. Alternatively, an engine manufacturer may communicate directly with the user.

An engine manufacturer may specify certain conditions which a user of a particular motor vehicle having an internal combustion engine manufactured by the manufacturer must accept as a prerequisite to the manufacturer agreeing to perform temporary recalibration.

The conditions include a limited duration for which use of the recalibrated engine is allowed. Duration of rental use may be measured in any of different ways such as by a defined length of time, by actual engine running time, or by miles traveled by a commercial truck.

Another condition is the price which a user must pay to a recipient designated by the engine manufacturer for rental use of the recalibrated engine. The recipient may be the engine manufacturer or an affiliate entity. The price for the limited duration of use may be correlated with difference between a first value of a performance parameter for the engine and a second value of the performance parameter for the engine. Rated power output of the engine and maximum torque output of the engine are examples of performance parameters for an engine.

Engine idle speed is another performance parameter. A user of a refrigerated delivery truck may want increased refrigeration for refrigerated cargo in summer to maintain proper cargo temperature while making a delivery. Renting a different engine idle speed during different seasons of the year or in diverse environments can provide better temperature control of a truck cabin bunk area.

The conditions may also include early termination of the limited duration of use accompanied by a reduction in the price paid to a recipient designated by the manufacturer.

Other possible conditions are at least one option which a user can elect or decline. One example is an option which allows the user to elect or decline the purchase of a warranty on the engine during the limited duration of allowed use, the option specifying terms of the warranty, including its price. Several different warranties may be offered based on length of the limited duration of allowed use and the difference between a first value of a particular performance parameter for the engine and a second value of the performance parameter for the engine.

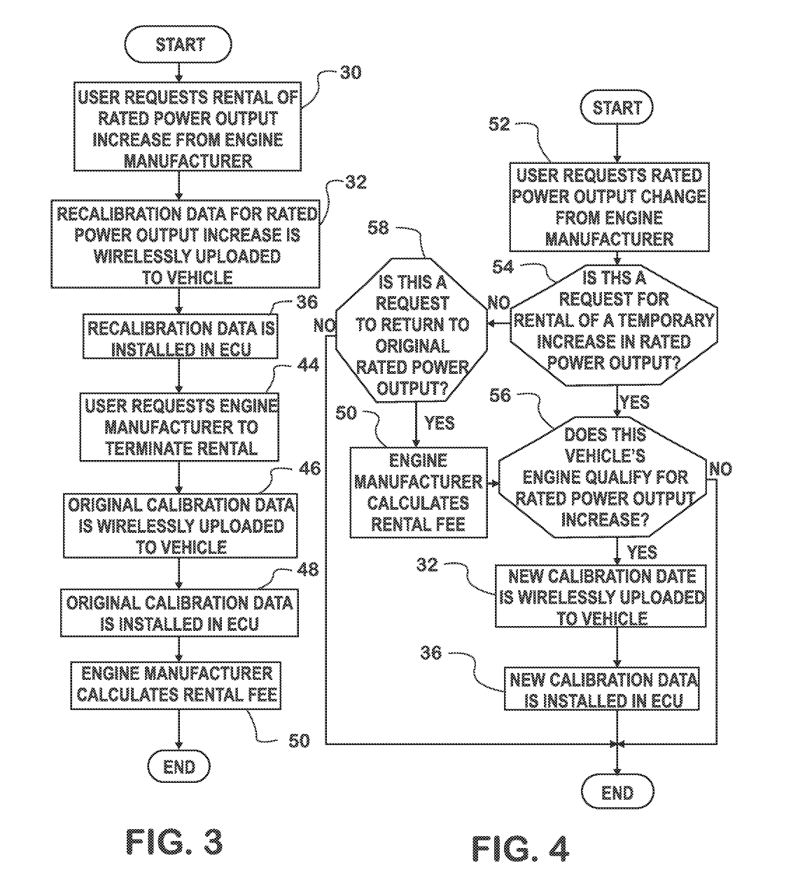

The following is an example of obtaining a rated output power increase as described with reference to FIG. 3.

The user first requests a rated output power increase (step 30) from the engine manufacturer. Payment arrangements are made between the user and the engine manufacturer, and then recalibration data for increased rated output power is uploaded (step 32) via wireless transmission (preferably secure), as portrayed in FIG. 1, from the engine manufacturer to a wireless receiver 34 in truck 10. An engine being recalibrated can be identified by its Vehicle Identification Number (VIN). A data link between receiver 34 and the ECU allows them to communicate with each other.

With engine 16 not running, the recalibration data received by receiver 34 is loaded to the ECU. The ECU contains suitable algorithms for causing the recalibration data to be installed in the ECU and to become operational to the exclusion of original calibration data in the ECU when engine 16 is re-started (step 36).

Engine 16 now has increased rated output power which is graphically illustrated in FIG. 2 by a broken line trace 38 which shows a relationship of engine output torque to engine speed over a range of higher engine speeds, and a broken line trace 40 which shows a relationship of engine output power to engine speed also over a higher engine speed range. Trace 40 has a maximum at the point marked 42, and that point quantizes the increased rated output power of engine 16, which is seen to be greater than the original rated output power marked at 28.

An engine manufacturer may offer increased rated output power and increased maximum output torque in any of several ways.

One way is by offering different sets of recalibration data, each of which provides a particular percentage increase, enabling a user to select one of the offered percentage increases. Rental price is a function of the magnitude of each percentage increase, with price increasing with increasing magnitude of percentage increase. Allowed rental time may decrease with increasing magnitude of percentage increase.

Another way to offer increases is by allowing a user to specify a particular percentage increase. If the requested percentage is acceptable to the engine manufacturer, the manufacturer will provide proper recalibration data, which if not available, may require the manufacturer to create it.

The duration for which power is rented may commence upon installation of the recalibration data, or upon engine re-start, or it may be determined by number of miles driven by truck 10. The duration may be limited by the engine manufacturer in any specified manner, such as by interaction with the truck's ECU which causes the ECU to revert to the original calibration upon expiration of the limited duration of allowed use. The user may be alerted in advance of the rental expiration to enable appropriate action to be taken if more rental time is needed.

Alternately, the user may issue a request to the engine manufacturer to terminate rental early (step 44). Had the engine manufacturer, prior to initially installing the recalibration data in the ECU, chosen to cause the original calibration data in the control system to be uninstalled and removed from the ECU, the manufacturer now initiates action which comprises wirelessly transmitting original calibration data to wireless receiver 34 for enabling engine 16 to be returned to original calibration (step 46). The received original calibration data is installed in the ECU and is rendered operational (step 48). The reduced rental fee is then calculated (step 50).

Had the original calibration not been removed from the ECU but rather only deactivated, it is reactivated by the engine manufacturer.

FIG. 4 shows an algorithm which implements the steps described in FIG. 3.

When a user request is made (step 52), a step 54 ascertains whether it is a request to initiate rental of a temporary increase in rated output power. If it is, a step 56 determines if the particular engine qualifies for recalibration. That can be determined in any appropriate way such as by the VIN number. If the engine qualifies, then steps 32 and 34 of FIG. 3, resulting in the engine becoming recalibrated to a new calibration providing increased rated output power.

If step 54 determines that a user request is not a request to initiate rental of a temporary increase in rated output power, a step 58 determines if it is a request for the engine to be returned to its original calibration, thereby terminating an existing rental. If is, step 50 of FIG. 3 is performed, followed by steps 32 and 34 which restore the original calibration as the new calibration.

If step 58 determines that a request is not a request that the engine to be returned to its original calibration, no further action is taken and the rental continues.

When a vehicle's engine experiences unexpected poor drivability which prevents the vehicle from being driven in a more or less conventional manner to a service facility, the vehicle's engine control system may enter what is commonly called a “limp-in” or “limp-home” mode of operation. During that mode, the user may wish to have the engine ECU recalibrated to provide better drivability and can do so by requesting rental of increased power for a limited duration as an alternative to having the vehicle towed.

When bobtailing (or when running at very light load), some commercial vehicle drivers may prefer to operate the transmission in a lower gear which can maintain a desired road speed but reduces fuel economy in the process. Operating the transmission in a higher gear to maintain the same road speed would be more fuel efficient. Hence a fleet operator can temporarily rent an attenuated torque curve for a fleet vehicle while it is bobtailing or towing a light load. Limiting torque can be done by choosing a lower power rating which may be a predefined one or alternatively by attenuating the engine torque curve by some percentage. To run the engine for better fuel economy when bobtailing or towing very light load, reduced rated engine power can be rented.

Certain recalibrations of an engine may affect tailpipe emissions, and that in turn may affect on-board diagnostics. Compliance with tailpipe emission regulations may be affected by political boundaries. Regulations may differ from one state or country to another. Operation of a vehicle within a state or country which has less restrictive regulations may offer an opportunity for fuel economy improvement when the vehicle has been certified for operation in a state or country whose regulations are more restrictive. Rental of a fuel-economy-improving recalibration for such a vehicle when operating in the less restrictive state or country may be cost-effective. Rental is limited to the time during which the vehicle is operating in that state or country.

During that time some or all of the on-board diagnostics may be turned off, or alternatively re-calibrated to be compatible with the engine recalibration.

A user may desire temporary recalibration based on how a vehicle is being used. For example, if a vehicle has a power takeoff, the engine will be running while the vehicle is stationary.

While over-the-air recalibration has been described in detail with reference to the drawing Figures, secure rental can be accomplished by different media, such as a wired communication at a service facility, or by a device which can be connected to a vehicle's electrical system to communicate with the engine control system and cooperate with an engine ECU to recalibrate the engine to temporarily increase its rated power output. Such a device can be paid for by the user and used as needed. It can have an initial value which is progressively depleted as the engine runs at increased rated output power, much like gift cards which have monetary value which depletes as the cards are used for purchases.

What is claimed is:

1. A method for enabling and causing an internal combustion engine of a motor vehicle to be recalibrated, for a limited duration of use, from a first calibration which sets a first value of a performance parameter for the engine, to a second calibration which sets a second value of the performance parameter different from the first value, the method comprising:
a manufacturer of the engine specifying conditions which a user of a motor vehicle having an internal combustion engine manufactured by the manufacturer must accept as a prerequisite to fulfillment of a request by the user for recalibration of the engine, the conditions including a limited duration for which use of the second calibration is allowed;
the user requesting, from a source having the manufacturer's authority to enable and cause the engine be recalibrated pursuant to the conditions, that the engine be recalibrated; and
upon being informed of the user's acceptance of the conditions, the source initiating actions of wirelessly transmitting data for the second calibration to a wireless receiver in the motor vehicle, causing the data for the second calibration to be installed in a control system of the engine and to become available for use by the control system at a beginning of the limited duration of use, and to become unavailable for use by the control system at an end of the limited duration of use.

2. The method as set forth in claim 1 including during the limited duration of use, measuring a parameter which is a measure of use of the data for the second calibration.

3. The method as set forth in claim 2 in which measuring the parameter which is a measure of use of the data for the second calibration comprises at least one of: measuring a defined interval of time; measuring actual engine operating time; and measuring distance traveled by the motor vehicle.

4. The method as set forth in claim 1 in which the second calibration, when in use, causes rated power output of the engine to be greater than prior rated power output of the engine when operating at the first calibration.

5. The method as set forth in claim 1 in which the second calibration, when in use, causes maximum torque output of the engine to be greater than prior maximum torque output of the engine when operating at the first calibration.

6. The method as set forth in claim 1 in which the conditions include the user paying a recipient designated by the manufacturer a price for the limited duration of use.

7. The method as set forth in claim 6 in which price for the limited duration of use is correlated with difference between the first value of the performance parameter for the engine and the second value of the performance parameter for the engine.

8. The method as set forth in claim 6 in which the conditions include allowing the user to terminate early the limited duration of use of the second calibration and to pay the recipient designated by the manufacturer a smaller price than price for the limited duration of use.

9. The method as set forth in claim 1 in which the conditions include at least one option which the user can elect or decline.

10. The method as set forth in claim 9 in which an option allows the user to elect or decline the purchase of a warranty on the engine during the limited duration of use, the option specifying terms of the warranty, including price.

11. A system for enabling an internal combustion engine of a motor vehicle to be recalibrated, for a limited duration of use, from a first calibration which sets a first value of a performance parameter for the engine, to a second calibration which sets a second value of the performance parameter different from the first value, the system comprising:
a data processor which operates under authority of a manufacturer of internal combustion engines and comprises a data base which includes: 1) data about various internal combustion engines manufactured by the manufacturer and used in various motor vehicles, the data base including data for recalibrating an engine in a selected vehicle from a first calibration which currently sets a first value of a performance parameter for the engine, to a second calibration which sets a second value of the performance parameter different from the first value, and 2) data which defines specific conditions which a user of a particular motor vehicle having an internal combustion engine manufactured by the manufacturer must accept as a prerequisite to the data processing system's fulfillment of a request by the user to recalibrate the engine of the particular motor vehicle, the conditions including a limited duration for which use of the second calibration is allowed;
a user interface via which the user can access the data processor to input certain information about the user's motor vehicle and engine for processing in accordance with an algorithm which discloses suitability of the engine for recalibration and which specifies conditions which the user must accept as a prerequisite to fulfillment of a request by the user for recalibration of the engine, and via which the user communicates to the data processor the user's acceptance of the conditions to cause the data processor to initiate recalibration of the engine of the particular motor vehicle.

12. The system as set forth in claim 11 in which the limited duration for which use of the second calibration is allowed is defined by a parameter which is a measure of use of the data for the second calibration.

13. The system as set forth in claim 12 in which the parameter which is a measure of use of the data for the second calibration comprises at least one of: a defined interval of time; actual engine operating time; and distance traveled by the motor vehicle.

14. The system as set forth in claim 11 in which the second calibration comprises second calibration data for causing rated power output of the engine to be greater than prior rated power output of the engine when operating at the first calibration.

15. The system as set forth in claim 11 in which the second calibration comprises second calibration data for causing maximum torque output of the engine to be greater than prior maximum torque output of the engine when operating at the first calibration.

16. The system as set forth in claim 11 in which the conditions include payment which the user is required to make to a recipient designated by the manufacturer for the limited duration of use.

17. The method as set forth in claim 16 in which price for the limited duration of use is correlated with difference between the first value of the performance parameter for the engine and the second value of the performance parameter for the engine.

18. The system as set forth in claim 16 in which the conditions include early termination of the limited duration of use of the second calibration and a reduced payment to the recipient designated by the manufacturer.

19. The system as set forth in claim 11 in which the conditions include at least one option which the user can elect or decline.

20. The system as set forth in claim 19 in which an option allows the user to elect or decline the purchase of a warranty on the engine during the limited duration of use, the option specifying terms of the warranty, including price.
